(19) United States
(12) Patent Application Publication
(10) Pub. No.: US 2002/0179368 A1
(43) Pub. Date: Dec. 5, 2002

(54) Post-tensioned fall protection system

(76) Inventor: David P. Evangelista, Jamestown, RI (US)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 10/158,162

(22) Filed: May 31, 2002

Related U.S. Application Data
(60) Provisional application No. 60/294,626, filed on Jun. 1, 2001.

(51) Int. Cl. A62B 1/16

(52) U.S. Cl. 182/3; 182/36

(57) ABSTRACT

A post-tensioned fall protection system including a beam-column having a first end and a second end; first and second end supports attached to the beam-column; a tensioned cable having a first end connected to the first end support and a second end connected to the second end support; a coupling device for connecting a lanyard to the tensioned cable; and at least one offset bracket attached to the beam-column between the first and second end supports for positioning the tensioned cable at a greater distance with respect to a neutral axis of the beam-column than at the end supports, wherein the coupling device can traverse from the first end of the tensioned cable to the second end of the tensioned cable past the at least one offset bracket.

### RELATED APPLICATIONS

This application claims priority under 35 U.S.C. §119 to U.S. Provisional Application No. 60/294,626 entitled Post-Tensioned Fall Protection System, filed on Jun. 1, 2001, the entire disclosure of which is expressly incorporated herein by reference.

### BACKGROUND OF THE INVENTION

1. Field of the Invention

The present invention relates to fall protection systems, and in particular, to post-tensioned fall protection system.

### BACKGROUND INFORMATION

Currently, as regulated (e.g., 29 CFR 1926.501) by the Occupational Safety and Health Administration (“OSHA”), employees or workers can be required to utilize fall protection measures at any time that they are more than six feet above a lower level. Otherwise, anytime an employee is exposed to a potential fall or does fall (i.e., greater than 6 feet), the employer can be subject to fines and/or other penalties. Facility owners, auditorium operators, architects and construction companies, as well as, other employers have recognized that providing fall protection for personnel that work at heights above six feet is not only required by law, but also provides a safe work environment conducive to productivity. OSHA regulations recognize several types of fall protection systems including fall restraint (i.e., guardrails), safety nets, fall arrest systems, positioning systems (i.e. mobile crane platforms and mobile scaffolds).

A fall arrest system can either be a cable based system or trolley beam system in either single-span or multi-span configurations. A span is a length of the fall arrest system between two points of the fall arrest system that are attached to an external structure (e.g. a structure used for purposes other than fall arresting). Typically, a worker using a fall arrest system wears a full harness equipped with a lanyard that can either be shock absorbing or part of a self-retracting mechanism. The lanyard is usually attached overhead to an attachment device (i.e. sliding collar or trolley) of the cable based or trolley beam system. The attachment device moves along the path of either a cable or rail with the worker, such that the worker can move about adjacent to and along the path. Cable based or trolley beam systems provide workers with the flexibility to safely perform their work, and yet can be least obtrusive from the workers' perspective.

An example of a known cable based system is a single-span cable system. The ends of the cable are anchored to or by the external environment in which the system will be used. A single-span cable system can utilize either a wire, twisted wire or synthetic rope for the cable. The single-span cable system provides fall protection about and along a straight line path between anchorages of the cable. Typically, the amount of pre-tension (i.e. 500 pounds) when a fall is not being arrested is just sufficient to minimize the deflection of the cable between spans due to the weight of the cable and an attachment device traveling along the cable (e.g. 500 pounds). In addition, a shock absorption element can be used between a cable and an anchorage to reduce the maximum amount of tension in a cable during an arrest of a fall. The amount of pre-tension applied to the cable, the maximum span of the cable and the use of shock absorption equipment can be important in determining the cable deflection that will occur during a fall.

Cable deflection is important when calculating the total fall distance of a worker, to ensure that the worker does not contact an object or surface below. A cable tension of up to 7,000 pounds can be required for a maximum deflection of more than one foot in a scenario of, for example, a worker being arrested at a midpoint of a forty foot span of the cable. Some mitigating factors for such a scenario would be the weight of the worker, as well as, the length and type (i.e. shock absorbing or self-retracting) of lanyard used in attaching the worker to the cable. However, safety equipment is not designed for the force or load of a worse case scenario, but rather is designed for at least twice the force or load of the worse case scenario. For example, OSHA rules require that the anchorage points of a cable based system have a safety factor of at least two. Thus, anchorages for the above scenario would have to be available within the external environment that are capable of resisting at least 14,000 pounds of lateral force.

Another example of a cable based system is a multi-span cable system that uses intermediate supports (e.g., centered at about 20 to 25 feet) between the anchorages of the cable to minimize cable deflection when a fall occurs. Cable tensions during a fall in multi-span cable system can range from 2,000 to 7,000 pounds of force depending upon the number of users assigned to a cable, maximum length of a span, as well as, other fall factors. The long length and configurational capabilities (i.e. varying direction) of a multi-span cable system can be suitable for overhead bridge cranes, building rooftops, high steel work, and multi-truck/railcar applications where appropriate supports or anchorages can be found or easily fitted/erected. Like a single-span cable system, a multi-span cable system needs anchorages available that are capable of resisting maximum cable tensions with a safety factor of at least two, as well as, the availability of external structures for placement of the intermediate supports.

Typically, a trolley beam system for fall protection utilizes a stiff structural component or components, such as an I-beam or series of I-beams bolted together, as a track that the attachment device travels along. Because the structural component of a trolley beam system has a very minimal deflection, it can be used where there is minimal overhead clearance so as to prevent worker from being struck by an element of the fall protection system when another worker falls. In addition, a trolley beam system does not require significant lateral support from the external environment in which the system will be used because the structural component(s) does not develop or have large lateral forces, like the lateral forces associated with cable based systems.

### SUMMARY OF THE INVENTION

The drawback of a single-span cable system is that the length of a span is limited by the amount of maximum tension that can be applied to prevent a maximum deflection in the cable when a fall occurs. The amount of maximum tension is dependent upon the availability or capability of anchorage points (i.e. capable of withstanding twice the maximum cable tension) within the external environment in which the system will be used. Because of the large cable deflections or anchorage requirements for large cable tensions with an appropriate safety factor, single-span cable systems are often limited to a short span. Likewise, the maximum span of a multi-span cable system has the drawback of being dependent upon the availability and capability of anchorage points in the external environment in which the system will be used.

A trolley beam system can not span long distances like a cable based system. The trolley beam system has the drawback of the structural component(s) being heavy in terms of weight per length (i.e., lb./ft.) of span. The weight of the structural component(s) is due to the size and configuration necessary to maintain a safety factor of at least two for arresting a fall at mid span without deformation. Thus, a trolley beam system for a long span can require the availability of anchorage points that have to be able to resist more load vertically than the anchorage points in a cable based system for such a span would have to resist laterally. Because of the size and/or weight of the structural component(s) for a given span, as opposed to the cable of a cable based system for the given span, a trolley beam system is more costly in terms of both manufacturing and rigging.

When designing and installing a cable-based fall protection system for an existing facility, the structure of the facility is analyzed to ensure that it is able to withstand lateral loads within required safety factors during the event of a fall. The inventor of the present application has found that this is a loading condition, which was not contemplated when some existing facilities were being designed and built. Therefore, supplemental structures have to be retrofitted to the existing facility. Installation of these supplemental structures can be labor and time intensive. For example, workers may have to repeatedly drill and weld from lifts or use temporary lifelines to attach the supplemental structures to the existing facility.

Accordingly, the present invention is directed to a fall protection system that substantially obviates one or more of the problems due to the limitations and disadvantages of the related art. The general approach of the present invention is to post-tension a cable at a distance with respect to a beam-column for long span fall protection with reduced cable deflections and reduced anchorage requirements. The post-tensioned fall protection system can, for example, be assembled on the ground and hoisted into position for attachment to points of an existing facility that can resist the loading conditions with an appropriate safety factor. In another example, the post-tensioned fall protection system can be attached to stanchions designed to support the post-tensioned fall protection system for a span between the stanchions.

In accordance with exemplary embodiments of the invention, a fall protection system includes a beam-column having a first end and a second end; first and second end supports attached to the beam-column; a tensioned cable having a first end connected to the first end support and a second end connected to the second end support; a coupling device for connecting a lanyard to the tensioned cable; and at least one offset bracket attached to the beam-column between the first and second end supports for positioning the tensioned cable at a greater distance with respect to a neutral axis of the beam-column than at the end supports, wherein the coupling device can traverse from the first end of the tensioned cable to the second end of the tensioned cable past the at least one offset bracket.

In accordance with exemplary embodiments of the invention, a fall protection system includes at least first and second system supports for supporting the fall protection system within an external environment; a beam-column having a span between the first and second system supports; a tensioned cable connected at opposite ends to the beam-column; a first offset bracket attached to the beam-column at a first intermediate point along the span for positioning the tensioned cable at a first distance with respect to a neutral axis of the beam-column; a second offset bracket attached to the beam-column at a second intermediate point along the span for positioning the tensioned cable at a second distance with respect to a neutral axis of the beam-column; the tensioned cable being connected to the beam-column through the first offset bracket and free to move along its length relative to the first offset bracket in a configuration such that a component of tensional force in the tensioned cable normal to the neutral axis is of the beam-column transferred through the first offset bracket to the beam-column, and connected to the beam-column through the second offset bracket and free to move along its length relative to the second offset bracket in a configuration such that a component of the tensional force in the tensioned cable normal to the neutral axis of the beam-column is transferred through the second offset bracket to the beam-column; a coupling device for connecting a lanyard to the tensioned cable; wherein the coupling device can traverse along the tensioned cable within the span past the first and second offset brackets.

In accordance with exemplary embodiments of the invention, a method for assembling a fall protection system includes providing a beam-column having at least first and second structural chords offset relative to a neutral axis of the beam-column; connecting a cable to the beam-column and across the at least first offset bracket that positions at least a portion of said cable eccentric to said neutral axis; pre-tensioning the cable such that the first structural chord is in tension and the second structural chord is in compression; and positioning an assembly of the beam-column, the at least first offset bracket, and the pre-tensioned cable such that gravitational forces cause the first structural chord to be in compression and the second structural chord is in tension.

Additional aspects and advantages of the invention will be set forth in the description that follows, and in part will be apparent from the description, or may be learned from practice of the invention. The aspects and advantages of the invention will be realized and attained by the system and method particularly pointed out in the written description and claims hereof, as well as, the appended drawings.

It should be emphasized that the terms “comprises,” “comprising,” “includes” and “including” when used in this specification, are taken to specify the presence of stated features, integers, steps or components; but the use of these terms does not preclude the presence or addition of one or more other features, integers, steps, components or groups thereof.

It is to be understood that both the foregoing general description and the following detailed description of the exemplary embodiments of the invention are exemplary only and are not restrictive of the invention, as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention that together with the description serve to explain the principles of the invention.

FIG. 1 is a side elevation view of an exemplary embodiment of a post-tensioned fall protection system in an exemplary external environment.

FIG. 2 is a side elevation view of the left end portion of the post-tensioned fall protection system shown in FIG. 1.

FIG. 3A is a cross-sectional view taken along line 3A-3A′ of the system in FIG. 2 for an exemplary embodiment of a triangular-shaped beam-column.

FIG. 3B is a cross-sectional view of an exemplary embodiment of a beam-column having a rectangular-shaped cross-section.

FIG. 3C is a cross-sectional view of an exemplary embodiment of a beam-column having an I-shaped cross-section.

FIG. 4 is a flowchart showing a method of assembling a post-tensioned fall protection system in accordance with an embodiment of the present invention.

FIG. 5 is an illustration of forces on an exemplary embodiment of a post-tensioned fall protection system after pre-tensioning of the cable.

FIG. 6 is an illustration of forces on an exemplary embodiment of a post-tensioned fall protection system when supported by system supports.

FIG. 7 is an illustration of forces on an exemplary embodiment of a post-tensioned fall protection system supported by system supports and subjected to a live load, such as during a fall.

FIG. 8 is an exemplary embodiment of a multi-span post-tensioned fall protection system.

### DETAILED DESCRIPTION

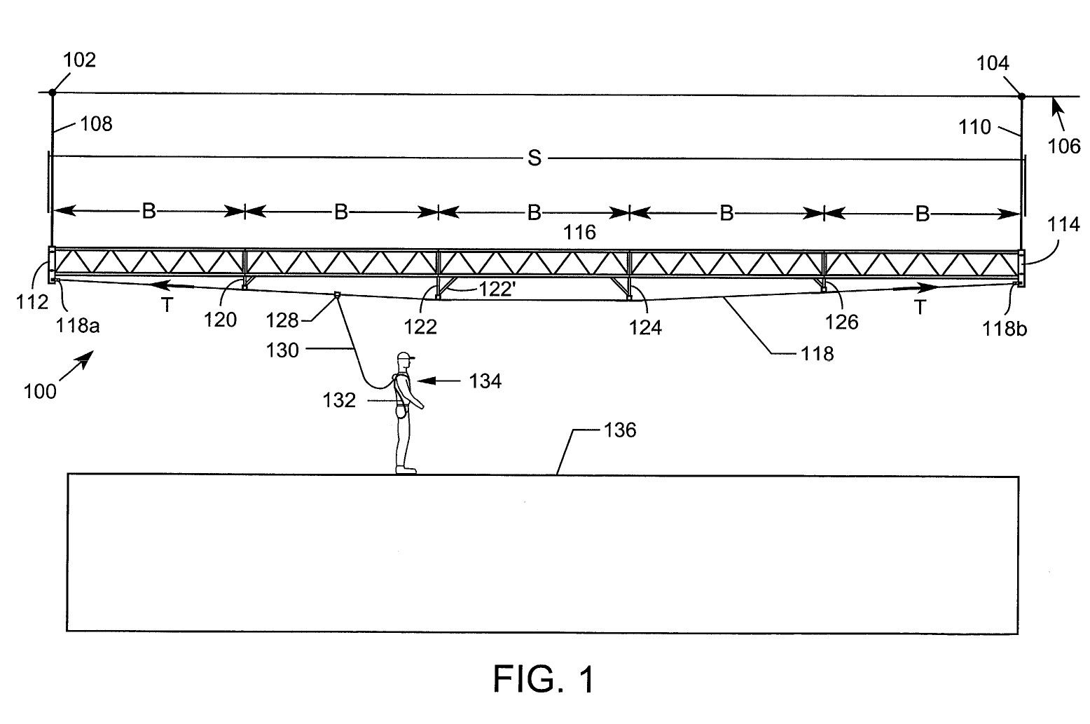

FIG. 1 illustrates an exemplary embodiment of a fall protection system 100 that spans a length S between two points 102 and 104 of an external environment, such as an existing facility. Examples of existing facilities that the system 100 can be used within include theaters, stadiums, arenas, bridges and other facilities where fall protection is appropriate for workers. As shown in FIG. 1, the system 100 is attached to a structure of an existing facility, such as roof truss 106. Other structures of an existing facility can be used, such as support columns, walls or other structures capable of supporting the weight of both the system 100 and fall loads with an appropriate safety factor. In the alternative, the system 100 can be connected to stanchions or other structures built to structurally support the system 100 in an external environment. For example, stanchions can be used in the external environment of a rail yard in which a fall protection system is positioned above workers on rail cars.

As shown in FIG. 1, cables 108 and 110 are respectively attached to the roof truss 104 and act as system supports for the fall protection system 100. System supports can be of any structural configuration, such as rods, bolts, welds, brackets or trusses capable of supporting the system. The system can be supported from either above or below the system, as well as, in the same plane of the system by the system supports. Any structural arrangement can be used as a system support that has an appropriate safety factor to resist loads from the system during a fall or concurring falls of the number of users for which the system is designed.

The system support cables 108 and 110, as shown in FIG. 1, are respectively attached to end supports 112 and 114. The ends 118a and 118b of the tensioned cable 118 are respectively connected to the end supports 112 and 114, which act as supports that resist the tensional force T of the tensioned cable 118 at the ends 118a and 118b. The cable ends 118a and 118b can be attached to the end supports with couplings or couplings with cable tensioners. The end supports can be of any structural configuration, such as posts, brackets or trusses capable of withstanding the tensional force T of the tensioned cable 118 during a fall in combination with any pre-tensioning load imposed upon the cable, and with an appropriate safety factor. The term “pre-tensioning” is interchangeably with “post-tensioning” and refers to the tension in the cable after the cable is assembled with the beam-column but before the complete assembly is installed at a location where fall protection is needed. The tensioned cable 188 can be made of wire rope or synthetic materials capable of withstanding the tensional force during a fall with an appropriate safety factor. In the alternative, there can be two or more tensioned cables connected between end supports. For example, two tensioned cables that are in a parallel configuration such that two users can pass one another within a span of the system.

The end supports 112 and 114 are also shown in FIG. 1 as respectively attached to the first end 116a and second end 116b of a beam-column 116. In the alternative, either or both of the end supports 112 and 114 can be placed anywhere along the span S of the beam-column 116 depending upon the length of fall protection desired within the span S. In an embodiment (not shown) where the end supports are positioned inboard from the ends of the beam-column, the outboard portions of the beam-column could extend in cantilever fashion beyond the system support cables. If there is more than one tensioned cable, either an additional set of end supports or single set of end supports can be used. Further, particularly if there are tensioned cables having different lengths, the end supports do not have to be used in sets for each tensioned cable since a single end support can be attached to more than one tensioned cable.

The system support cables 108 and 110 of FIG. 1 are attached to the end supports 112 and 114. In the alternative, instead of the system support cables 108 and 110 being attached to the end members 112 and 114, the system support cables 108 and 110 can be attached to the beam-column 116. As long as an appropriate safety factor to resist loads during a fall is maintained, system supports can be connected to the end supports, the beam-column or both.

As shown in FIG. 1, offset brackets 120, 122, 124 and 126 are attached to the beam-column 116 at intermediate points along the span S between the end support members 112 and 114. The offset brackets 120, 122, 124 eccentrically position the tensioned cable 118 with respect to the beam-column 116 along the span S but allow the cable to move along its length relative to the offset brackets. As shown in FIG. 1, the offset brackets 120, 122, 124 and 126 are equidistantly spaced at a distance B between the end supports 112 and 114. The length of distance B or bay spacing is dependent upon the desired amount of maximum cable deflection that will occur during a fall given an initial pretension in the tensioned cable 118. The maximum deflection of the tensioned cable 118 decreases as the distance B reduces. However, decreasing the distance B increases the overall weight of the system because of an increased number of offset brackets. Therefore, equidistant spacing of the offset brackets is not required but aids in achieving a desired maximum cable deflection while minimizing an overall increase in the weight of the system.

Attached to the tensioned cable 118 in FIG. 1 is a coupling device 128 configured to move, slide or roll along the tensioned cable 118 such that the coupling device can traverse from one end 118a to the other end 118b of the tensioned cable 118. For example, the coupling device can be a collar or a trolley mechanism. There can be at least one coupling device for each tensioned cable within a system. The coupling device 128 is for connecting a lanyard 130, either shock absorbing or self retracting, to the tensioned cable 118. The lanyard 130 is attached to a harness 132, either full body or belt, that is worn by a user 134 on an elevated surface 136.

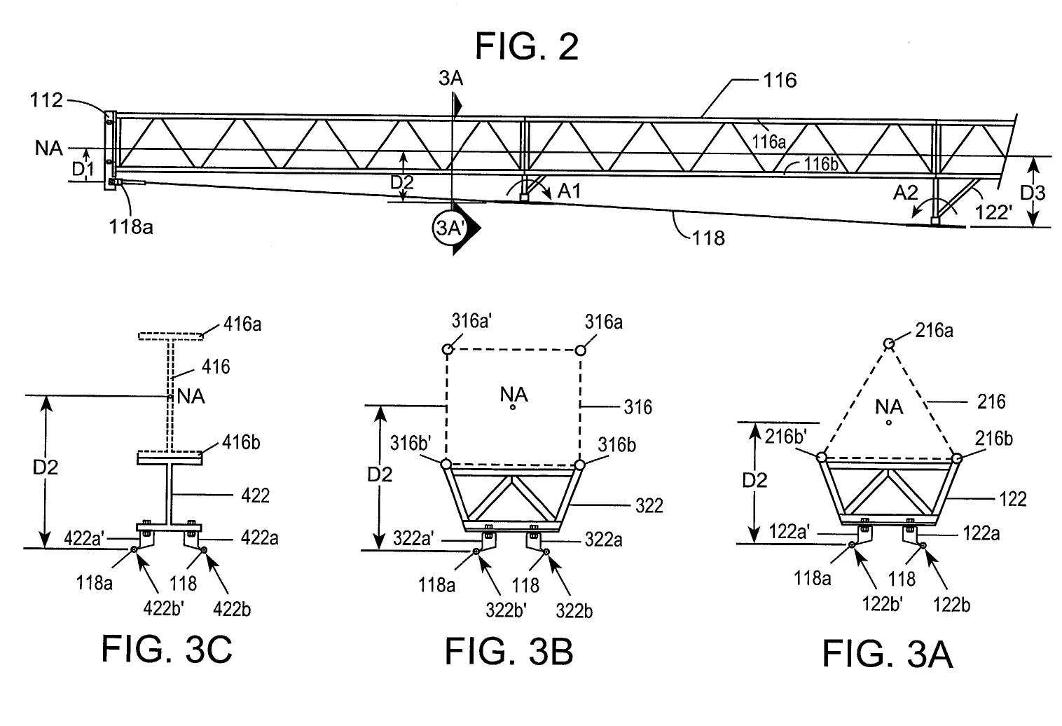

FIG. 2 is a plan view of the left end portion of the post-tensioned fall protection system shown in FIG. 1. The beam-column 116 has neutral axis NA as shown in FIG. 2. Offset relative to the neutral axis are a first structural chord 116a and second structural chord 116b of the beam-column. As shown in FIG. 2, the end support 112 offsets the tensioned cable a distance D1, which is greater distance from the neutral axis NA than the offset distance of both the first and second structural chords 116a and 116b. The offset bracket 120 in FIG. 2 offsets the tensioned cable 118 a distance D2, which is greater than the distance D1. Further, the offset bracket 122 offsets the tensioned cable 118 a distance D3, which is a greater distance from the neutral axis NA than the distance D1.

As shown in FIG. 2, a cable angle A1 between the tensioned cable 118 on one side of the offset bracket 120 and the tensioned cable on the other side of the offset bracket 120 is 180 degrees. Because the tensioned cable 118 is at a cable angle of 180 degrees or goes straight through offset bracket 120, and is free to move along its length relative to the offset bracket 12, substantially no component of the tensional force T is transferred to the beam-column 116. The offset bracket 120 or offset brackets having a cable angle of 180 degrees are used primarily to reduce the distance B or bay spacing to maintain a desired maximum cable deflection during a fall.

The cable angle A2 in FIG. 2 between the tensioned cable 118 on one side of the offset bracket 122 and the tensioned cable on the other side of the offset bracket 122 is less than 180 degrees. Because the angle A2 is less than 180 degrees, a vertical component Ty1 of tensional force T, as shown in FIG. 2, is transferred through the offset bracket 122 to the beam-column 116. The component Ty1 is normal to the neutral axis NA of the beam-column 116. Because the cable is free to move along its length relative to the offset bracket 122, the horizontal component Tx1 of the tensional force T resulting from the change in direction of the cable at the offset bracket is relatively small and easily resisted by a bracing leg 122′, best seen in FIG. 1. The offset bracket 122 or offset brackets having a cable angle of less 180 degrees are used to both reduce bay spacing and act like a post in transferring a shear force to the beam-column 116. The vertical shear force Ty1 exerted on the beam-column by the pre-tensioning of cable 118 will counteract and at least partially cancel vertical loads generated by the weight of the beam-column and live loads.

FIG. 3A is a cross-sectional view along line A-A′ of the system in FIG. 2 for an exemplary embodiment of a beam-column having a triangular shape, such as triangular truss 216. The triangular truss 216 has a structural chord 216a offset relative to one side of the neutral axis NA and structural chords 216b and 216b′ offset relative to another side of the neutral axis NA. A truss-like offset bracket 122, as shown in FIG. 3A, is attached to the triangular truss 216 adjacent to the structural chords 216b and 216b. The truss-like offset bracket 122 includes an intermediate bracket 122a for attaching to a tensioned cable 118 such that the coupling device can traverse along the tensioned cable and go past the offset bracket 122. The intermediate bracket 122a can include a portion 122b that goes around the tensioned cable 118. Thus, a coupling device travels freely across the portion 122b of the intermediate bracket 122. FIG. 3A also shows that another tensioned cable 118a can be attached to the offset bracket with another intermediate bracket 122a′ that can include a portion 122b′ that goes around a tensioned cable 118a.

FIG. 3B is an exemplary embodiment of a beam-column having a rectangular-shaped cross-section, such as box truss 316. The box truss 316 has structural chords 316a and 316b′ offset relative to one side of the neutral axis NA and structural chords 316b and 316b′ offset relative to another side of the neutral axis NA. A truss-like offset bracket 322, as shown in FIG. 3B, is attached to the triangular truss 316 adjacent to the structural chords 316b and 316b. The truss-like offset bracket 322 can include intermediate brackets 322a and 322b with respective portions 322a′ and 322b′ for attaching to a tensioned cable like described above with respect to FIG. 3A.

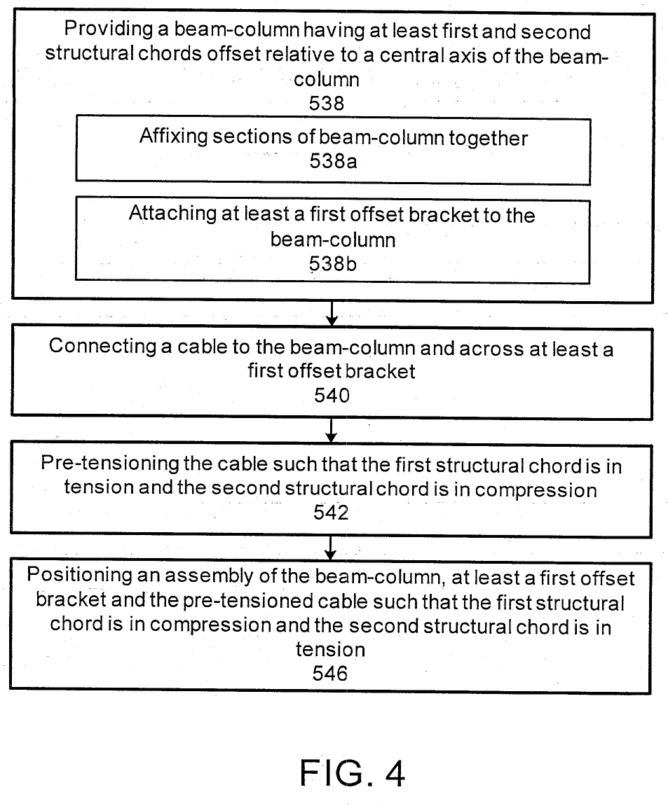

FIG. 3C is an exemplary embodiment of a beam-column having a I-shaped cross-section, such as I truss 416. The I truss 416 has a structural chord or flange 416a offset relative to one side of the neutral axis NA and structural chord or flange 416b offset relative to another side of the neutral axis NA. An I-shape offset bracket 422, as shown in FIG. 4B, is attached to the I-truss 416 adjacent to the structural chords 416b. The I-shaped offset bracket 422 can include intermediate brackets 422a and 422b with respective portions 422a′ and 422b′ for attaching to a tensioned cable like described above with respect to FIGS. 3A and 3B.

FIG. 4 is a flow chart of a method of assembling a fall protection system in accordance with an embodiment of the present invention. Assembling the fall protection system, such as system 100, can include providing a beam-column having at least first and second structural chords offset relative to a neutral axis of the beam-column, as shown in step 538 of FIG. 4. The beam-column can comprise of a single structural element. In an alternative, the beam-columns can comprise of sections for ease in transport to a work site and/or for ease in adapting an overall length of the system to a given external environment. Sections of the beam-column can be welded, bolted or affixed together with other types of fastening mechanisms. Thus, providing a beam-column can include affixing the beam-column together as shown in 538a of FIG. 4. Providing the beam-column can also include attaching at least a first offset bracket to the beam-column, as shown in 538b of FIG. 4. The offset brackets can either be attached directly to a side of the beam-column, between sections of the beam-column or both. Likewise, the end supports can either be attached directly to a side of the beam-column, between sections of the beam-column or both. Both the offset brackets and the end supports can be welded, bolted or affixed to the beam-column with other types of fastening mechanisms.

Assembling a fall protection system, such as system 100, can include connecting a cable to the beam-column and across the at least first offset bracket, as shown in step 540 of FIG. 4. The ends of the cable, such as cable ends 118a and 118b can be attached to end supports, such as end supports 112 and 114 as shown in FIG. 1. In the alternative, the ends of the cable can be attached to the beam-column, or one end of the cable can be attached to the beam-column and the other end attached to an end support.

After the cable is connected, the cable is pre-tensioned such that the first structural chord is in tension and the second structural chord is in compression, as shown in step 542 of FIG. 4. The pre-tensioning of the cable can be done, for example using cable tensioners, such as turnbuckles, attached between the ends of the cable and the end supports. Another exemplary method of pre-tensioning the cable is attaching the cable to the end supports and then using a levering action of the end supports with respect to the beam-column when the end supports are bolted on to the beam-column. In another alternative, other tensioning methods that pre-tension the cable across the end supports and then connecting the cable to the end supports can be utilized. For example, a hydraulic device can be used to apply pretension to the cable and then the cable is connected to the end supports. The cable is position eccentric to the neutral axis of the beam-column by one or more offset brackets spaced at intermediate points along the span of the beam-column. The offset brackets are designed to maintain a desired spacing between the cable and the beam-column while allowing the cable to move along its length relative to the offset bracket.

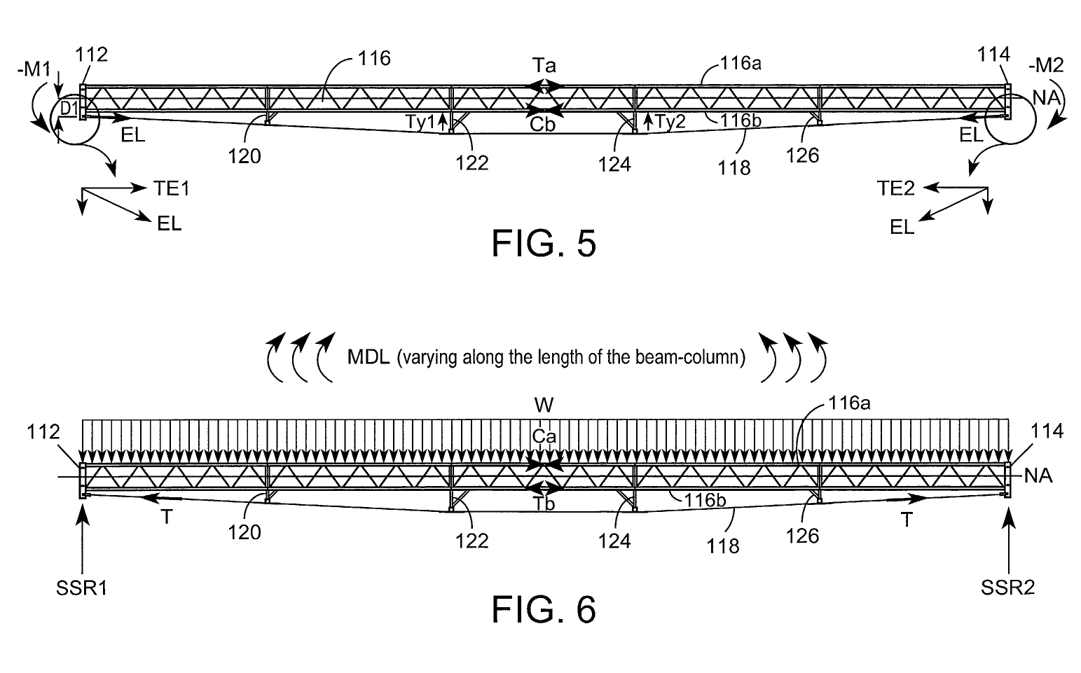

The fall protection system can be assembled on a surface, such as on the ground, so that workers can easily assemble and pre-tension the system. For example, the system can be assembled such that the system is lying on the ground and not subjected to the gravitational forces caused by its weight. Thus, the weight of the system is generally distributed along the surface, such as the ground, that is in contact with the system. FIG. 5 is an illustration of forces on an exemplary embodiment of a system, such as system 100, after pre-tensioning of the cable and before mounting the system at its point of use. As shown in FIG. 5, the tensional force T of the tensioned cable 118 imparts a force EL on the end supports 112 and 114. The force EL on each of the end supports 112 and 114, respectively has horizontal components TE1 and TE2 that are normal to the end supports 112 and 114. In addition, offset brackets having a cable angle of less than 180, such as offset brackets 122 and 124, transfer a shear force normal to the beam-column, such as Ty1 and Ty2, from the tensional force T. The horizontal components TE1 and TE2 of the force EL on the end supports and the vertical shear components Ty1 and Ty2 create negative bending moments −M1 and −M2 on the beam-column, as shown in FIG. 5. The negative bending moments on the system put the structural chord 116b, on the side of the beam-column toward the tensioned cable 118, into compression Cb and the structural chord 116a, which is on an opposite side of the neutral axis NA, into tension TA.

The negative bending moments −M1 and −M2 of FIG. 5 are shown as equal. However, the negative bending moments can be unequal. For example, one end support can offset the tensioned cable a distance from the beam-column that is different from a distance that another end support offsets the tensioned cable from the beam-column. Another example, is that one end of the cable is offset a distance from the beam-column and the other end of the cable is attached to the beam-column.

After the fall protection system is pre-tensioned, the method of assembling can then include positioning the assembly of the beam-column, at least a first offset bracket, and the pre-tensioned cable such that the weight of the assembly causes the structural chord on the top side of the beam-column to be in compression and the second structural chord on the bottom side of the beam-column to be in tension, as described in step 546 of FIG. 4. The system can be lifted or placed such that the system can be attached to system supports. In the alternative, the system can be positioned by the system supports. For example, cables later used for supporting the system can be used for positioning the system.

FIG. 6 is an illustration of forces on an exemplary embodiment of a post-tensioned fall protection system, such as system 100, when supported by system supports at the end supports during a dead load or as a static situation. The weight W of the system created by the mass of the beam-column, offset brackets, end supports and cable acted on by gravitational forces is resisted at the end supports of the system by reactions SSR1 and SSR2, and results in the positive bending moment of MDL that varies along the length of the beam-column 116, as shown in FIG. 6, that is greater than the negative bending moments −M1 and −M2, as discussed above with respect to FIG. 5. In the alternative, the positive bending moment MDL can be less than the negative bending moments −M1 and −M2 as result of the magnitude of pre-tension in the tensioned cable in combination with the eccentricity of the tensioned cable. The positive bending moment of MDL on the system put the structural chord 116b, which is on the side of the neutral axis NA toward the tensioned cable 118, into tension Tb and the structural chord 116a, which is on an opposite side of the neutral axis NA, into compression Ca.

Other negative bending moments can act on the beam-column. For example, a cantilevered portion of the beam-column overhanging an end support can be used to produce a negative bending moment. The weight of the cantilevered portion can create a negative bending moment that can partially or totally offset the positive bending moment from the weight of the system within the span depending on the position along the beam-column at which the system supports are attached to the beam-column.

The control of the bending moments enables long spans between system supports. By pre-tensioning a cable across offset brackets to offset stresses within the beam-column, a long span with low weight can be achieved. In addition, pre-tensioning a cable across offset brackets with a placement of system supports to provide a cantilever effect can provide a longer span.

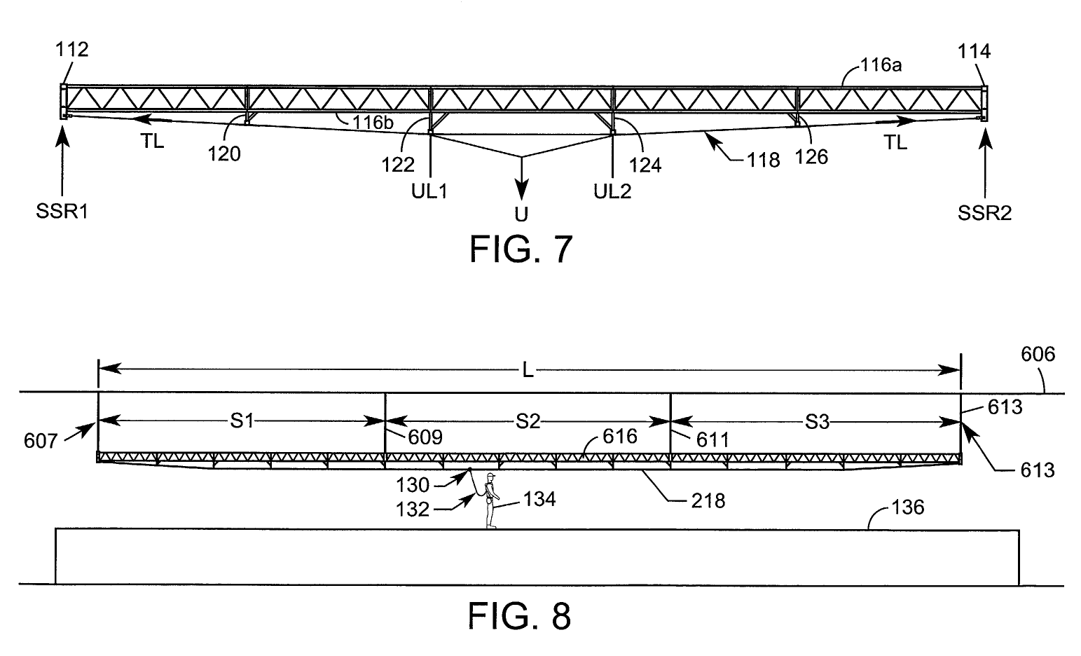

FIG. 7 is an illustration of forces on an exemplary embodiment of a post-tensioned fall protection system, such as system 100, when supported by system supports at the end supports during a live load or fall. As shown in FIG. 7, if a fall occurs between offset brackets 122 and 124, portions of the user's load U will be transferred to the offset brackets 122 and 124 respectively as UL1 and UL2. In addition, an increased tensional force TL will occur in the tensioned cable 118. The portions UL1 and UL2 of the user's load U increase the positive bending moments by adding to the system overall weight, while the increased tensional force TL transferred to the end supports will increase the negative bending moments about the neutral axis NA of the beam-column. Thus, the negative bending moments from increased tensional force TL will partially offset the positive bending moments created by the portions UL1 and UL2 of the user's load U transferred to the beam-column through the offset brackets 122 and 124.

FIG. 8 is an exemplary embodiment of a multi-span post-tensioned fall protection system 600 that has spans S1, S2 and S3. The system 600 is attached to an existing facility 606 by the four system supports 607, 609, 611 and 613. A tensioned cable 218 extends across all three spans. In the alternative, different individual tensioned cables can extend across each span of beam-column 616.

As shown in FIG. 8, the spans S1, S2 and S3 are equidistant. The length of an individual span can be dependent upon availability of attachment points to an existing facility or a stanchion. Equidistant spans are not required but are beneficial in that the weight of a fall protection system is evenly distributed across the system supports of the system.

The invention has been described with reference to a particular embodiments. However, it will be readily apparent to those skilled in the art that it is possible to embody the invention in specific forms other than those of the embodiment described above. This can be done without departing from the spirit of the invention. The embodiments described herein are merely illustrative and should not be considered restrictive in any way. The scope of the invention is given by the appended claims, rather than the preceding description, and all variations and equivalents which fall within the range of the claims are intended to be embraced therein.

What is claimed is:

1. A fall protection system comprising:
a beam-column having a first end and a second end;
first and second end supports attached to the beam-column;
a tensioned cable having a first end connected to the first end support and a second end connected to the second end support;
a coupling device for connecting a lanyard to the tensioned cable; and
at least one offset bracket attached to the beam-column between the first and second end supports for positioning the tensioned cable at a greater distance with respect to a neutral axis of the beam-column than at the end supports, wherein the coupling device can traverse from the first end of the tensioned cable to the second end of the tensioned cable past the at least one offset bracket.

2. The fall protection system of claim 1, wherein the beam-column spans between first and second stanchions.

3. The fall protection system of claim 1, wherein an angle between the tensioned cable on one side of the offset bracket and the tensioned cable on the other side of the offset bracket is less than 180 degrees.

4. The fall protection system of claim 1, wherein the offset bracket comprises:
an intermediate bracket attached to the tensioned cable in a configuration such that the coupling device can traverse across a portion of the intermediate bracket on the tensioned cable.

5. The fall protection system of claim 1, comprising:
another tensioned cable connected between the first and second end supports.

6. The fall protection system of claim 1, wherein the offset bracket comprises:
a first intermediate bracket attached to the tensioned cable; and the fall protection system further including a second tensioned cable connected between the first and second end supports; and
a second intermediate bracket attached to the second tensioned cable.

7. The fall protection system of claim 1, wherein a cross-section of the beam-column is one of a triangular-shape, rectangular shape and I-shape.

8. A fall protection system comprising:
at least first and second system supports for supporting the fall protection system within an external environment;
a beam-column having a span between the first and second system supports;
a tensioned cable connected at opposite ends to the beam-column;
a first offset bracket attached to the beam-column at a first intermediate point along the span for positioning the tensioned cable at a first distance with respect to a neutral axis of the beam-column;
a second offset bracket attached to the beam-column at a second intermediate point along the span for positioning the tensioned cable at a second distance with respect to a neutral axis of the beam-column;
the tensioned cable being connected to the beam-column through the first offset bracket and free to move along its length relative to the first offset bracket in a configuration such that a component of tensional force in the tensioned cable normal to the neutral axis is of the beam-column transferred through the first offset bracket to the beam-column, and connected to the beam-column through the second offset bracket and free to move along its length relative to the second offset bracket in a configuration such that a component of the tensional force in the tensioned cable normal to the neutral axis of the beam-column is transferred through the second offset bracket to the beam-column;
a coupling device for connecting a lanyard to the tensioned cable; wherein the coupling device can traverse along the tensioned cable within the span past the first and second offset brackets.

9. The system of claim 8, wherein the first and second system supports respectively include first and second stanchions.

10. The system of claim 8, wherein the tensioned cable has first and second ends that are connected at a third distance from the neutral axis to first and second end supports, respectively, said third distance being less than the first and second distances.

11. The fall protection system of claim 8, wherein an angle between the tensioned cable on one side of the first offset bracket and the tensioned cable on the other side of the first offset bracket is less than 180 degrees.

12. The fall protection system of claim 8, wherein the first offset bracket comprises:
an intermediate bracket attached to the tensioned cable in a configuration such that the coupling device can traverse across a portion of the intermediate bracket on the tensioned cable.

13. The fall protection system of claim 8, wherein the first offset bracket comprises:
a first intermediate bracket attached to the tensioned cable; and the fall protection system further including a second tensioned cable connected at opposite ends to the beam-column; and
a second intermediate bracket attached to the second tensioned cable.

14. The fall protection system of claim 8, wherein a cross-section of the beam-column is one of a triangular-shape, rectangular shape and I-shape.

15. The fall protection system of claim 8, wherein the offset bracket has an I-shaped cross-section.

16. The fall protection system of claim 8, wherein the tensional force is defined by tensions of two or more tensioned cables.

17. The fall protection system of claim 8, wherein there are more than two system supports.

18. A method for assembling a fall protection system comprising:
providing a beam-column having at least first and second structural chords offset relative to a neutral axis of the beam-column;
connecting a cable to the beam-column and across the at least first offset bracket that positions at least a portion of said cable eccentric to said neutral axis;
pre-tensioning the cable such that the first structural chord is in tension and the second structural chord is in compression; and
positioning an assembly of the beam-column, the at least first offset bracket, and the pre-tensioned cable such that gravitational forces cause the first structural chord to be in compression and the second structural chord is in tension.

19. The method of assembling a fall protection system in claim 18, wherein providing a beam-column includes affixing sections of beam-column together.

20. The method of assembling a fall protection system in claim 18, wherein providing a beam-column includes attaching the at least first offset bracket to the beam-column.
